(19) United States
(12) Patent Application Publication
(10) Pub. No.: US 2008/0190372 A1
(43) Pub. Date: Aug. 14, 2008

(54) PET FOOD TRAY

(76) Inventor: George A. Horvath, Bonita Springs, FL (US)

Correspondence Address: EDWARD M. LIVINGSTON, PA, 963 TRAIL TERRACE DRIVE, NAPLES, FL, 34103, US

(21) Appl. No.: 11/674,699

(22) Filed: Feb. 14, 2007

(51) Int. Cl. A01K 5/01; A01K 5/00

(52) U.S. Cl. 119/61.56; 119/51.01; 119/61.5

(57) ABSTRACT

A pet food tray (1) comprising a planar horizontal surface (2) having at least one opening (8) located therein for acceptance of a bowl (9), a front wall (3) and an opposing rear wall (4) attached perpendicularly to the horizontal surface (2) and two opposing side walls (5 and 6) attached perpendicularly to the horizontal surface (2). At least one aperture (7) is located within the side walls (5 and 6) to permit a user to easily carry the pet food tray (1). At least one leg (11) is secured to the horizontal surface (2) so as to raise the horizontal surface (2), and thus at least one bowl (9), a predetermined distance above a ground surface. Alternate embodiments of the present invention include the bowl as a permanent feature of the horizontal surface (2) and a securing means to permit a user to lock the bowl within the opening via flanges (25 and 26). In addition, the leg(s) (11) may be telescopingly adjustable or removable.

### BACKGROUND OF THE INVENTION

This invention relates to pet food trays, more particularly, a pet food tray that permits a user to easily transport filled pet food and water bowls from one location to another without spilling food or water onto a ground surface.

Many pet owners and pet caretakers find the task of feeding and providing water to a pet messy and awkward as oftentimes the owner and/or caretaker fills the food and water bowls at one location within a home, such as in the kitchen, and transports the filled bowls to another area of the home so the pet may eat and drink the food and water. However, when the filled bowls are transported to the second location, oftentimes food and/or water drops onto the floor for a variety of reasons, such as the owner/caretaker being unable to steadily and evenly hold the filled bowls due to muscle atrophy, arthritis or other ailments, overfilling the filled bowls, the pet itself jumping onto the owner/caretaker, etc. In addition, even if the filled bowls are being transported a minimal distance, such as from a kitchen sink or kitchen counter to a kitchen floor, if any of the aforementioned reasons arises, food and/or water is still dropped onto the floor.

Thus, a need exists for a pet food tray that permits a pet owner/caretaker to easily transport filled pet food and water bowls to a remote location without spilling food and/or water onto a ground surface.

The relevant prior art includes the following references:

| U.S. Pat. No. | | |
|---|---|---|
| (U.S. unless stated otherwise) | Inventor | Issue/Publication Date |
| 4,699,089 | Teschke | Oct. 13, 1987 |
| 2005/0115508 | Little | Jun. 02, 2005 |
| Des. 424,759 | Sipka | May 09, 2000 |
| Des. 393,107 | Tsengas | Mar. 31, 1998 |
| 5,509,376 | Tsengas | Apr. 23, 1996 |
| 6,705,249 | Quinlan et al. | Mar. 16, 2004 |
| 5,884,582 | Duckworth | Mar. 23, 1999 |
| 6,145,474 | Lemkin | Nov. 14, 2000 |

### SUMMARY OF THE INVENTION

The primary object of the present invention is to provide a pet food tray that permits a user to transport filled pet food and water bowls from one location to another without spilling food or water onto a ground surface.

A further object of the present invention is to provide a pet food tray that minimizes the amount of food and water dropped or splashed onto a ground or wall surface when a pet is eating or drinking.

An even further object of the present invention is to provide a pet food tray that is easy to use.

Another object of the present invention is to provide a pet food tray that is adjustable in height.

A further object of the present invention is to provide a pet food tray that is attractive.

An even further object of the present invention is to provide a pet food tray that can be customized.

The present invention fulfills the above and other objects by providing a pet food tray having a planar horizontal surface with at least one opening located therein for acceptance of a bowl, a front wall and an opposing rear wall attached perpendicularly to the horizontal surface and two opposing side walls attached perpendicularly to the horizontal surface. At least one aperture is located within the side walls to permit a user to easily carry the pet food tray. At least one leg is secured to the horizontal surface so as to raise the horizontal surface, and thus at least one bowl, a predetermined distance above a ground surface. Alternate embodiments of the present invention include the bowl as a permanent feature of the horizontal surface and a securing means to permit a user to lock the bowl within the opening via flanges. In addition, the leg(s) may be telescopingly adjustable or removable.

To use the present invention, a user places food or water into the desired bowl and carries the pet food tray via the apertures on the side walls to a location to feed a pet. Because the four walls surround the horizontal surface and are raised a predetermined distance above the horizontal surface, even if food or water falls or splashes out of the bowl, the food or water will not spill onto a ground surface.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a perspective plan view of a first embodiment of a pet food tray of the present invention;

FIG. 2 is a top view of a first embodiment of the pet food tray of the present invention;

FIG. 3 is a bottom view of the first embodiment of the pet food tray of the present invention without legs;

FIG. 4 is a plan view of a second embodiment of the pet food tray of the present invention;

FIG. 5 is a top view of third embodiment of the pet food tray of the present invention; and

FIG. 6 is a bottom view of a bowl having flanges that is insertable into the pet food tray of the present invention.

### DESCRIPTION OF THE PREFERRED EMBODIMENTS

For purposes of describing the preferred embodiment, the terminology used in reference to the numbered components in the drawings is as follows:

| | |
|---|---|
| 1. | pet food tray, generally |
| 2. | horizontal surface |
| 3. | front wall |
| 4. | rear wall |
| 5. | first side wall |
| 6. | second side wall |
| 7. | aperture |
| 8. | opening |
| 9. | bowl |
| 10. | rim |
| 11. | leg |
| 12. | name plate |
| 13. | first edge |
| 14. | second edge |
| 15. | third edge |
| 16. | fourth edge |
| 17. | leg holder |
| 18. | top surface |
| 19. | bottom surface |
| 20. | inner leg |
| 21. | outer leg |
| 22. | pin |
| 23. | pin aperture |
| 24. | non-skid surface |
| 25. | aperture flange |
| 26. | bowl flange |

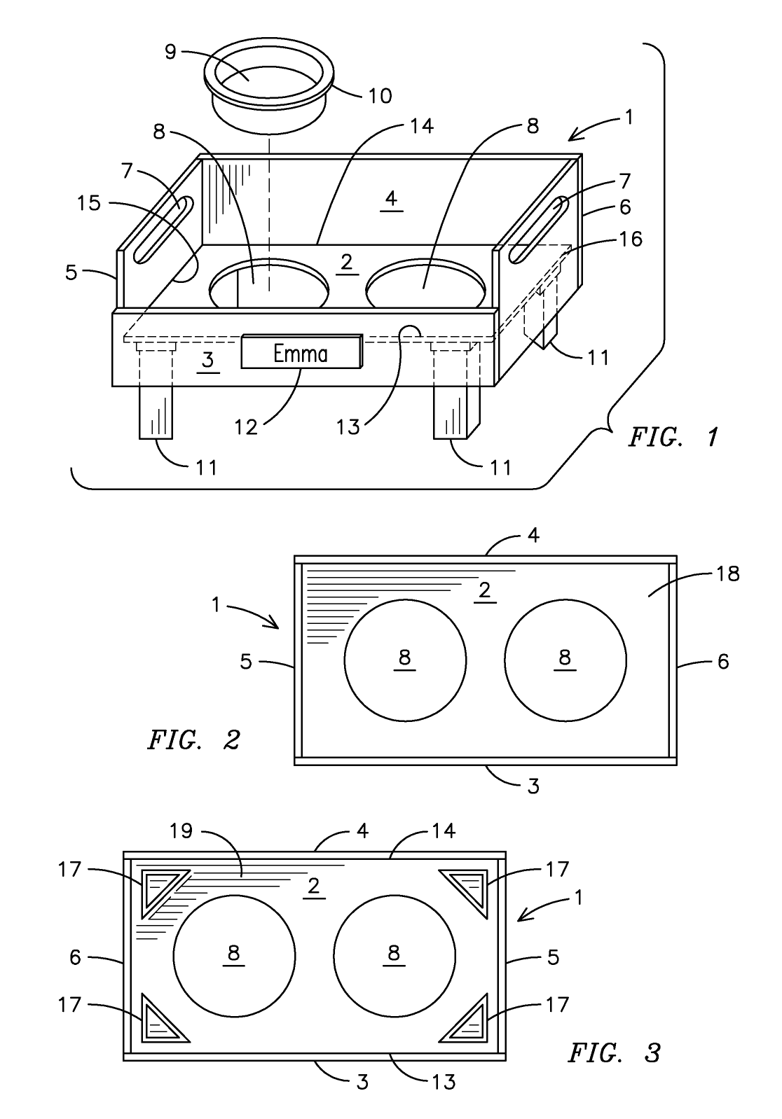

With regards to FIG. 1, a perspective plan view of a first embodiment of a pet food tray of the present invention is shown. The pet food tray, generally 1, includes a substantially planar horizontal surface 2 having a first edge 13, a second edge 14, a third edge 15 and a fourth edge 16 which form a substantially rectangular shape. A front wall 3 having a predetermined height is secured perpendicularly to the first edge 13 and an opposing rear wall 4 having a predetermined height is secured perpendicularly to the second edge 14. A first side wall 5 having a predetermined height is secured to the third edge 15 and an opposing second side wall 6 having a predetermined height is secured to the fourth edge 16. Thus, the walls 3, 4, 5 and 6 form an enclosure around the horizontal surface 2. At least one opening 8 is located on the horizontal surface 2 that is predeterminedly sized for the acceptance of a bowl 9, which preferably includes a rim 10 so as to retain the bowl 9 within the opening 8. However, the opening 8 may be sized slightly smaller than the bowl 9 so as to retain the bowl 9 within the opening 8. At least one aperture 7 is located on either one or both side walls 5 and 6 to permit a user to carry the pet food tray 1 easily. At least one leg 11 is permanently or removably secured to the horizontal surface 2 so as to raise the horizontal surface 2 a predetermined distance above a ground surface. Legs 11 of varying heights may be used so as to adjust the height of the pet food tray 1 so as to accommodate pets of various sizes. In addition, a name plate 12 may be located on the front wall 3 so as to customize the pet food tray 1.

Next, with reference to FIGS. 2 and 3, a top and bottom view of a first embodiment of the pet food tray of the present invention without legs is shown. The horizontal surface 2 has a top surface 18 and a bottom surface 19. At least one leg holder 17 is located on the bottom surface 19 of the horizontal surface 2 so as to retain the legs 11 therein. Thus, a user may interchange legs 11 of various heights. The leg holders 17 and corresponding legs 11 may be of any shape, including, but not limited to, square, triangular, round, etc.

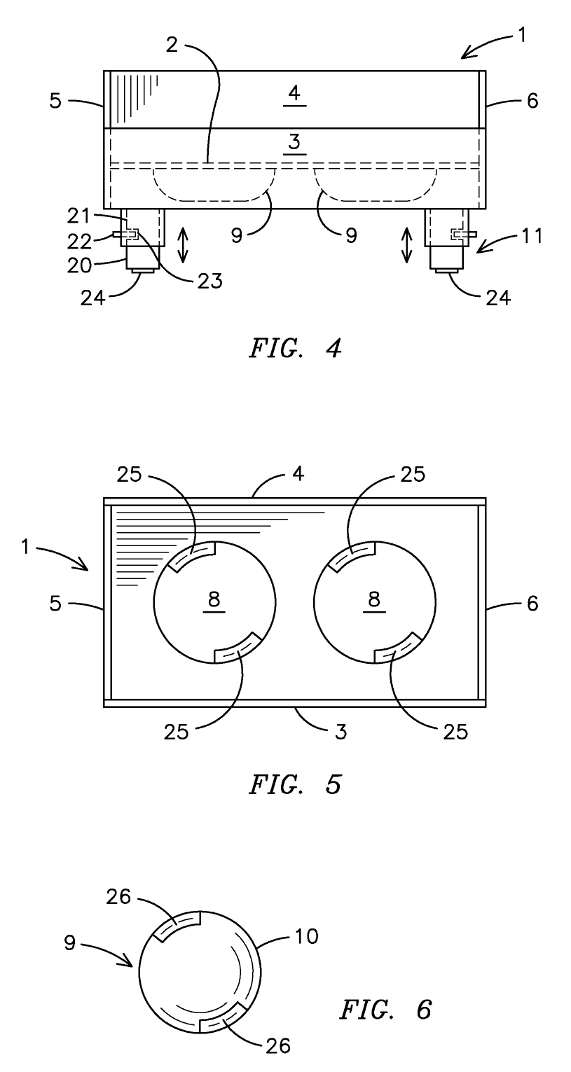

FIG. 4 shows a plan view of a second embodiment of the pet food tray of the present invention. Rather than having removable bowls 9, the second embodiment of the pet food tray 1 includes at least one permanent bowl 9 located within the horizontal surface 2. In addition, the legs 11 of the second embodiment are telescoping wherein an inner leg 20 is insertable within an outer leg 21, so the height of the pet food tray 1 can be adjusted according to a pet's size. To adjust the height of the legs 11, a user removes a pin 22 from a pin aperture 23 located in the inner leg 20 and at least one pin aperture 23 located in the outer leg 21, extends raises or lowers the outer leg 21 upon the inner leg 20 so as to match the outer leg 21 pin aperture 23 with the desired inner leg 20 pin aperture 23 and inserts the pin 22 into the corresponding pin apertures 23. A non-skid surface 24 may be located on a bottom of the legs 11 so as to prevent the pet food tray 1 from sliding when a pet is eating or drinking.

Finally, FIGS. 5 and 6 show a top view of third embodiment of the pet food tray 1 of the present invention and a bowl used in conjunction with the third embodiment, respectively. The third embodiment includes the apertures 8 having at least one aperture flange 25 and a bowl 9 having at least one bowl flange 26 located along the bowl rim 10. The aperture flange 25 and the bowl flange 26 correspond with one another so as to provide a securing means wherein the bowl 9 is locked into the aperture 8 when the flanges 25 and 26 overlap and is released when the flanges 25 and 26 are not overlapping.

To use the pet food tray 1, a user removes the bowls 9 from the horizontal surface 2 and fills the bowls 9 with food or water. The user then inserts the filled bowls 9 into the apertures 8 and carries the pet food tray 1 to a desired location for feeding. Because the walls 3, 4, 5 and 6 are raised a predetermined distance above the horizontal surface 2, even if food or water spills from the bowls 9, the food or water will not fall onto the ground surface. In addition, a user may adjust the legs 11 prior to filling the bowls 9 so as to accommodate his/her pet size. If using removable bowls 9, the user may remove the bowls 9 and wash the bowls 9 so as to maintain sanitary conditions. In the alternative, if using a pet food tray 1 having permanent bowls 9, a user may wipe the bowls 9 clean.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not be considered limited to what is shown and described in the specification and drawings.

Having thus described my invention, I claim:

1. A pet food tray comprising:
a substantially planar horizontal surface having a top and a bottom;
said horizontal surface having at least one opening for acceptance of a bowl;
a bowl for insertion and removal from said at least one opening;
said horizontal surface having a first edge and an opposing second edge;
said horizontal surface having a third edge and opposing fourth edge;
said first edge is joined to said third edge at approximately ninety degrees;
said third edge is joined to said second edge at approximately ninety degrees;
said second edge is joined to said fourth edge at approximately ninety degrees;
said fourth edge is joined to said first edge at approximately ninety degrees;
a front wall having a predetermined height perpendicularly secured to said horizontal surface first edge;
a rear wall having a predetermined height perpendicularly secured to said horizontal surface second edge;
a first side wall having a predetermined height perpendicularly secured to said horizontal surface second edge;
a second side wall having a predetermined height perpendicularly secured to said horizontal surface fourth edge; and
at least one leg secured to said horizontal surface bottom wherein said at least one leg raises said horizontal surface a predetermined distance above a ground surface.

2. The pet food tray of claim 1 further comprising:
at least one aperture located on said first side wall.

3. The pet food tray of claim 2 further comprising:
at least one aperture located on said second side wall.

4. The pet food tray of claim 1 wherein:
said at least one leg is removable from said horizontal surface bottom.

5. The pet food tray of claim 1 wherein:
said at least one leg includes an inner leg and an outer leg wherein said inner leg telescopes within said outer leg

6. The pet food tray of claim 5 further comprising:
a locking means on said at least one leg.

7. The pet food tray of claim 6 wherein:
said outer leg has at least one pin aperture;
said inner leg has at least one pin aperture; and
said locking means is a removable pin that is positioned into said outer leg at least one pin aperture and said inner leg at least one pin aperture.

8. The pet food tray of claim 1 further comprising:
at least one securing means for securing said bowl within said at least one opening.

9. The pet food tray of claim 8 wherein:
said securing means is at least one flange located along said at least one opening interlockable with at least one flange located along a rim on said bowl.

10. A pet food tray comprising:
a substantially planar horizontal surface having a top and a bottom;
said horizontal surface having at least one opening for acceptance of a bowl;
a bowl for insertion and removal from said at least one opening;
said bowl having a rim;
at least one flange located along said at least one opening;
at least one flange located along said bowl rim;
said horizontal surface having a first edge and an opposing second edge;
said horizontal surface having a third edge and opposing fourth edge;
said first edge is joined to said third edge at approximately ninety degrees;
said third edge is joined to said second edge at approximately ninety degrees;
said second edge is joined to said fourth edge at approximately ninety degrees;
said fourth edge is joined to said first edge at approximately ninety degrees;
a front wall having a predetermined height perpendicularly secured to said horizontal surface first edge;
a rear wall having a predetermined height perpendicularly secured to said horizontal surface second edge;
a first side wall having a predetermined height perpendicularly secured to said horizontal surface second edge;
a second side wall having a predetermined height perpendicularly secured to said horizontal surface fourth edge; and
at least one leg secured to said horizontal surface bottom wherein said at least one leg raises said horizontal surface a predetermined distance above a ground surface.

11. The pet food tray of claim 10 further comprising:
at least one aperture located on said first side wall.

12. The pet food tray of claim 11 further comprising:
at least one aperture located on said second side wall.

13. The pet food tray of claim 10 wherein:
said at least one leg is removable from said horizontal surface bottom.

14. The pet food tray of claim 10 wherein:
said at least one leg includes an inner leg and an outer leg wherein said inner leg telescopes within said outer leg

15. The pet food tray of claim 15 further comprising:
a locking means on said at least one leg.

16. The pet food tray of claim 15 wherein:
said outer leg has at least one pin aperture;
said inner leg has at least one pin aperture; and
said locking means is a removable pin that is positioned into said outer leg at least one pin aperture and said inner leg at least one pin aperture.

17. A pet food tray comprising:
a substantially planar horizontal surface having a top and a bottom;
said horizontal surface having at least one bowl;
at least one flange located along said at least one opening;
at least one flange located along said bowl rim;
said horizontal surface having a first edge and an opposing second edge;
said horizontal surface having a third edge and opposing fourth edge;
said first edge is joined to said third edge at approximately ninety degrees;
said third edge is joined to said second edge at approximately ninety degrees;
said second edge is joined to said fourth edge at approximately ninety degrees;
said fourth edge is joined to said first edge at approximately ninety degrees;
a front wall having a predetermined height perpendicularly secured to said horizontal surface first edge;
a rear wall having a predetermined height perpendicularly secured to said horizontal surface second edge;
a first side wall having a predetermined height perpendicularly secured to said horizontal surface second edge;
a second side wall having a predetermined height perpendicularly secured to said horizontal surface fourth edge; and
at least one leg secured to said horizontal surface bottom wherein said at least one leg raises said horizontal surface a predetermined distance above a ground surface.

18. The pet food tray of claim 17 further comprising:
at least one aperture located on said first side wall.

19. The pet food tray of claim 18 further comprising:
at least one aperture located on said second side wall.

20. The pet food tray of claim 17 wherein:
said at least one leg is removable from said horizontal surface bottom.

21. The pet food tray of claim 17 wherein:
said at least one leg includes an inner leg and an outer leg wherein said inner leg telescopes within said outer leg

22. The pet food tray of claim 21 further comprising:
a locking means on said at least one leg.

23. The pet food tray of claim 22 wherein:
said outer leg has at least one pin aperture;
said inner leg has at least one pin aperture; and
said locking means is a removable pin that is positioned into said outer leg at least one pin aperture and said inner leg at least one pin aperture.
